(19) United States
(12) Patent Application Publication
(10) Pub. No.: US 2010/0099025 A1
(43) Pub. Date: Apr. 22, 2010

(54) Wet cell battery

(76) Inventor: Joe Brown, Grass Valley, CA (US)

Correspondence Address: BLACK LOWE & GRAHAM, PLLC, 701 FIFTH AVENUE, SUITE 4800, SEATTLE, WA, 98104, US

(21) Appl. No.: 12/214,182

(22) Filed: Jun. 16, 2008

(51) Int. Cl. H01M 6/04; H01M 10/44

(52) U.S. Cl. 429/188; 320/128

(57) ABSTRACT

An improved lead-acid battery is disclosed including a sulfurless electrolyte believed to have the chemical formula H₉O₄.

### TECHNICAL FIELD

The invention relates to wet cell batteries. More specifically, the invention relates to lead-acid wet cell batteries.

### BACKGROUND OF THE INVENTION

Gaston Planté was a French physicist who is generally acknowledged to have invented the lead-acid battery in 1859. The lead-acid battery eventually became the first commercial rechargeable electric battery. His early model consisted of two sheets of coiled lead soaked in sulfuric acid. In the following year he presented a 9-cell lead-acid battery to the French Academy of Sciences. In 1881, Camille (Emile Alfonse) Faure would develop a more efficient and reliable model that saw success in early electric cars. Faure's improvement included a process for making lead paste to “fill in” what has today become a lead grid, providing the plate with tremendous surface area for use with both a positive and negative plate in a lead-acid battery.

Since that time over 100 years ago, there have been numerous improvements in lead-acid battery technology with respect to the mechanical structure of such batteries or, “wet cells.” However, the basic electrochemistry of how the battery is formed, charged and maintained after the battery is manufactured has not changed substantially.

Before a lead-acid battery can be used it must be “formed.” During forming, the active material on the cathode plate withdraws the sulfuric acid which was used in the lead paste manufacturing process. The dissolving and removing of the sulfuric acid allows the lead oxide molecules to become interstitial to the act of coating. Some manufacturers use a very low specific gravity sulfuric electrolyte for this forming process and when the action is complete will have an electrolyte of standard 1.280 specific gravity. Other manufacturers form hundreds of plates at the same time in large tanks. These plates are then washed with water and dried in ovens. After they are manufactured into batteries they are called “dry formed” batteries. These batteries are shipped to dealers in their dry state and sulfuric acid electrolyte of 1.280 standard gravity is added for sale. Some particular improvement to the structure of lead-acid battery manufacturing has been use of the technique described in U.S. Pat. No. 6,060,198 titled Electrochemical Battery Structure and Method, issued May 9, 2000 to Snaper, where the structure of the cathode plate is made of lead sponge instead of a lead grid.

With reference to FIG. 1 of the drawings, those of ordinary skill in the art will appreciate that a conventional lead-acid battery generally indicated at reference numeral 10 in FIG. 1 consists of a fluid impermeable case 12 containing an electrolyte in solution 14, typically a dilute mixture of sulfuric acid (H₂SO₄) and water (H₂O). The sulfuric acid disassociates in water to form sulfate anions (SO₄²⁻ aq) and hydrogen cations (H⁺). An anode plate 16 consists primarily of lead (Pb) and is selectively electrically communicated through a load 18 to a cathode 20 typically a mesh grid structure coated with a lead peroxide paste (PbO₂). In a commercial battery, an ion porous separator 19 is interposed between the anode and cathode plates 16, 20 to prevent them from coming into mechanical contact with one another thus creating an electrical short. The anode and cathode are selectively placed in electrical communication through the load 18 by a switch 22. To discharge the battery or wet cell 10 through the load 18, the switch 22 is closed causing chemical reactions to occur at both the anode 16 and cathode 20. During discharge, lead from the anode 16 combines with aqueous sulfite anions to form lead sulfate in solid form liberating two electrons. This reaction can be chemically described as follows:

Pb(s)+SO₄²⁻(AQ)→PbSO₄(s)+2e⁻.

The electrons travel through the switch 22 and load 18 into the cathode 20 where lead peroxide in solid form combines with aqueous sulfate anions and four hydrogen cations including the two electrons which were liberated from the anode forming lead sulfate on the surface of the cathode and two water molecules. This reaction can be chemically described as follows:

PbO₂(s)+SO₄²⁻(AQ)+4H⁺+2e⁻→PbSO⁴(s)+2H₂O(l).

As is well known to those of ordinary skill in the art, to recharge the battery the load may be removed and a reverse polarity applied to the cathode and anode such that the above chemical reactions are reversed. Care must be taken to prevent overcharging the battery which will cause the water in the electrolyte solution to boil exposing the anode and cathode. If portions of the anode and cathode are exposed during discharge, adverse mechanical reactions will occur to the plates.

Although lead-acid batteries have become remarkably successful in the motive-industries, lead-acid wet cells suffer from various limitations and disadvantages. A well maintained lead-acid battery for use in the motive industry (e.g., forklifts) can be expected to have a battery service life of 5 to 7.5 years. In order to obtain this long life cycle, it is critical that the batteries be properly maintained, charged and discharged. It is well known that discharging a battery to more than 80% of its capacity (also known as “depth of discharge” or “DOD”) prior to recharging seriously degrades the mechanical characteristics of the battery. Conversely, failing to fully discharge the battery before recharging, limits the battery's duty cycle and operation. For this reason, industrial concerns which rely heavily on the use of the lead-acid batteries for motive technology typically employ swappable battery packs so that while one battery pack is charging, the other battery pack may be utilized to run the motive device (e.g., forklift). By way of example, General Motors Corporation operates over 13,000 forklifts in its North America operations. Each forklift is associated with three separate battery packs which are rotated into the forklift so that no individual battery pack is discharged below 80% of its depth of discharge rating. The primary reason to limit the depth of discharge of industrial motive lead-acid batteries is to prevent the batteries from sulfating. Sulfating is probably the single most damaging reaction (other than freezing) in a lead-acid electrochemical battery. Sulfating is understood to occur during the normal discharge process of a lead-acid electrochemical battery and is apparent from the equations given above. During the normal discharge process, lead and sulfur from the aqueous sulfate anion combine into soft lead sulfate crystals which are formed in the pores and on the surface of both the anode and the cathode plates inside the lead-acid battery. When a battery is left in a substantially discharged condition, continually undercharged, or the electrolyte level is below the top of the plates or stratified, some of the soft lead sulfate recrystallizes into hard lead sulfate. This hard lead sulfate often cannot be reconverted to soft lead sulfate or aqueous lead sulfate during subsequent recharging sessions. This creation of the hard sulfate crystals is commonly called “permanent” or “hard” sulfation. When present, the battery shows a higher voltage than its true voltage; thus, fooling the voltage regulator in the charging apparatus into thinking that the battery is fully charged. This causes the charger to prematurely lower its output current, leaving the battery undercharged resulting in further sulfation during the next charge sequence. Sulfation accounts for approximately 85% of the lead-acid battery failures in batteries that are not used at least once per week. The longer sulfation occurs, the larger and harder the lead sulfate crystals become. The positive plates (i.e., cathodes) will be light grey and the negative plates (i.e., anodes) will be a dull, off-white color. These crystals lessen the battery's capacity and ability to recharge. This is because deep cycle and some starting batteries are typically used for short periods, vacations, weekend trips, etc., are then stored for the rest of the year to slowly self-discharge. Lead-acid motive batteries are typically used continuously. Thus, sulfation is due to other maintenance issues, primarily failure to maintain adequate electrolyte levels. Over time, the hard sulfate crystals burrow into the anode and cathode plates causing the surface of the plates to crack and slough off, causing conductive particulates to float down through the electrolyte to the bottom of the battery. Should these particles bridge the gap between the plates, they short circuit the plates to the detriment of the wet cell. The problem is exacerbated when the battery gets hot and expands due to high current demand on the battery, or from the recharging process itself causing further cracks and sloughing off of the battery plates. All of the above problems can be attributed to the presence of sulfur in the sulfuric acid electrolyte.

Thus, a need exists for a lead-acid battery using an electrolyte which does not cause sulfation.

A further need exists for a lead-acid battery which may be discharged to below 80% of its depth of discharge capacity without deleterious effect.

Yet a further need exists for lead-acid battery which can be overcharged without generating significant dangerous hydrogen gas.

### BRIEF SUMMARY OF THE INVENTION

It is therefore an object of the present invention to provide for a wet cell lead-acid battery which uses a substantially sulfur-free electrolyte.

It is a further object of the present invention to provide a wet cell lead-acid battery which achieves the above object and which also may be discharged to its depth of discharge capacity without significant damage.

It is yet another object of the present invention to provide for a wet cell lead-acid battery which achieves the above objects and which also could be quickly recharged and/or overcharged without generating significant hydrogen gas and while maintaining its service life.

The invention achieves the above objects, and other objects and advantages which will become apparent from the description which follows, by providing a conventional lead-acid wet cell battery employing a sulfur-free electrolyte.

In a preferred embodiment of the invention, an improved wet cell battery includes a substantially fluid impervious battery case, an anode plate, a cathode plate, and an ion porous separator therebetween. All of the above are substantially received in the battery case and a substantially sulfur-free electrolyte in solution with water is utilized in the battery case. The improved wet cell battery employs an electrolyte including an acid having the chemical formula H₉O₄ termed in the alternate, “activated water,” “RSSA-T,” “MAX-LITE” or “MxLte.” In the improved wet cell battery, the anode/cathode plates are manufactured, formed and not charged prior to introduction of the electrolyte into the battery such that the electrolyte is not introduced into a formed (dry charged) cell.

The invention includes a method for reforming a wet cell battery previously used with a sulfuric acid electrolyte. In the preferred method, an electrical load is placed on the battery so as to safely discharge the battery substantially completely. Thereafter, the battery is preferably short circuited for approximately 24 hours. The battery is then emptied of substantially all sulfuric acid electrolytes and flushed at least twice with water so as to remove all the sulfuric acid electrolyte. The battery is then filled with substantially sulfurless electrolyte and a reforming charge of at least approximately twice to five times the capacity of the battery is applied. In one embodiment of the preferred method, the electrolyte is substantially sulfurless and has the chemical formula H₉O₄.

### BRIEF DESCRIPTION OF THE DRAWINGS

FIG. 1 is a schematic representation of a prior art wet cell battery and related chemical reactions.

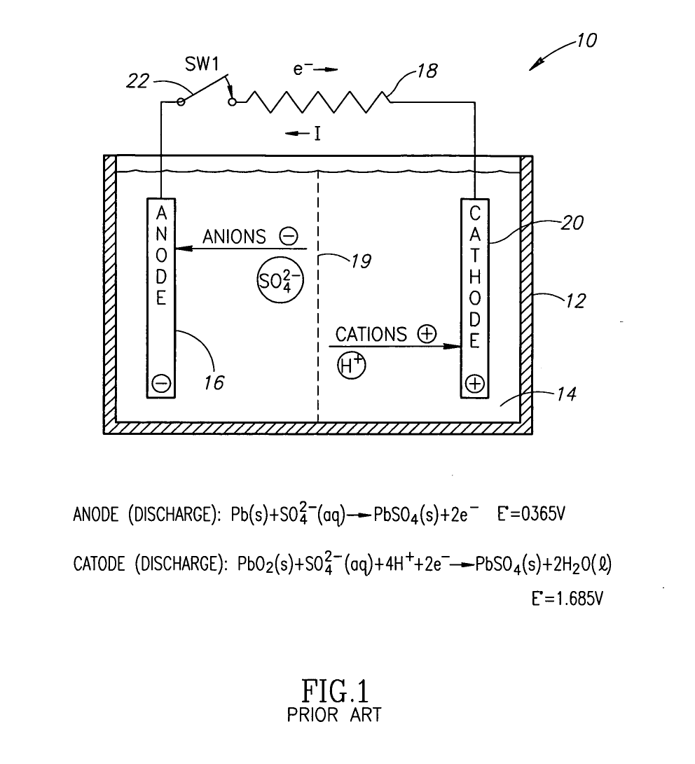

FIG. 2 is a perspective view of a motive, swapable wet cell battery pack.

FIG. 3 is a graph comparing test data for conventional wet cell batteries, and various types of batteries employing the invention electrolyte.

### DETAILED DESCRIPTION OF THE PREFERRED EMBODIMENTS

A lead-acid wet cell battery pack in accordance with the principles of the invention is generally indicated at reference numeral 30 in the various Figures of the attached drawings wherein numbered elements in the Figures correspond to like numbered elements herein.

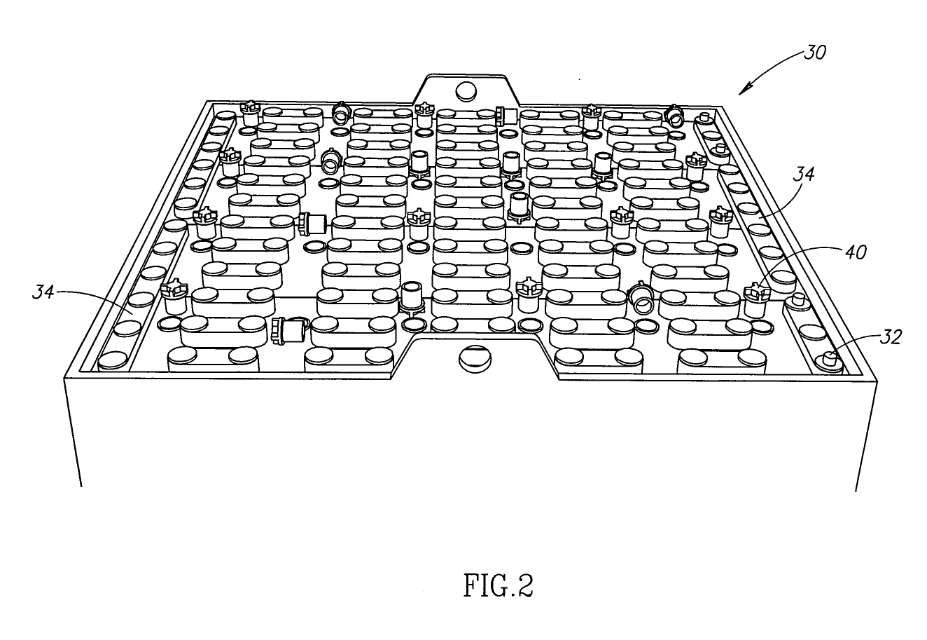

The battery pack 30 shown in FIG. 2 is specifically adapted for use in motive power type technologies such as forklifts wherein the duty cycle, life cycle and power requirements on such batteries are particularly onerous. Nevertheless, the principles of the present invention may be applied to lead-acid wet cell batteries used in a variety of different applications including but not limited to the following: automotive starting; standby power; solar power; railroad use; gel cells; deep cycle batteries; and electric car propulsion. The battery pack 30 has been used in conjunction with forklifts and consists of a plurality of individual batteries 32 connected in series by straps 34 so as to achieve the desired voltage (e.g., 24 volts, 36 volts, 48 volts, etc.). The battery is of conventional construction and is described with respect to the prior art above. The batteries are contained in a steel housing 36 having lift points 38 which allows the battery pack 30 to be removed as a unit from the forklift or the like. Each battery 32 has a plurality of vent caps 40 which permit hydrogen gas generated during the recharging process to be vented to the atmosphere and to permit water, electrolyte and/or electrolyte solution to be introduced into the batteries.

In the battery pack 30 shown in FIG. 2, the batteries 32 are conventional batteries which have been reformed using an electrolyte of the present invention so as to preclude sulfation of the battery plates. The preferred electrolyte does not contain sulfur as in sulfuric acid but is an electrolyte containing H₉O₄ or stable hydronium. Solutions of this type have been previously developed for cleaning metal surfaces, particularly non-ferrous alloys such as copper, brass and high strength aluminum alloys. The use of this solution as an electrolyte for a lead-acid battery has led to unanticipated results including: longer battery life; a battery pack that can be overcharged without sulfating damage; increased battery capacity; deep discharge/charge cycles; and faster charging eliminating the need for multiple battery packs for association with individual forklifts. The currently preferred method of preparing the electrolyte is disclosed at paragraphs 0017 through 0039 of U.S. Patent Application No. U.S.2003/0189009 A1 to Wurzburger, published Oct. 9, 2003 and titled “Method for Concentrating Ions in a Solution.” Nevertheless, for purposes of disclosure, the preferred method of forming the preferred electrolyte is recited below.

In step 1, a solution is placed in a container and the temperature of the solution is reduced to a temperature that is just below the freezing temperature of the pure solvent so that the solution becomes “slushy”. One portion of the solution has solidified leaving a second portion that is liquid. The second portion has a greater concentration of ions than the first portion as a result of the partial freezing step.

In step 2, the solution of solid and liquid is passed through a filter that separates the solid portion from the liquid portion.

The following steps are for preparing a concentrated solution of hydronium ions.

In step 1, reagent grade concentrated sulfuric acid (98%) is added to distilled H₂O so as to create a solution being 1.5 to 2.0 mole of sulfuric acid in water. This solution is permitted to mix for sufficient time to allow total dissociation of H₂SO₄ into H₃O⁺ ions and SO₄⁻ ions.

In step 2, a gram mole equivalent (1.5 to 2.0 moles) of reagent grade calcium metal turnings or calcium hydride (CaH₂) is slowly added to the solution. The solution is mixed until the reaction goes to completion and the solution cools to below 100° F.

In step 3, the solution is immobilized whereby most of the precipitated calcium sulfate settles on the bottom of the mix tank.

In step 4, the solution is decanted to separate the settled precipitate from the solution.

In step 5, the decanted solution is passed through a 10 micron fiberglass filter to separate out remaining particulates of calcium sulfate.

The following is a second part of the process to complete concentration of the hydronium ions.

In step 1, the filtered solution is placed in a high strength nalgene container of one to five gallons and placed in a freezing device so as to reduce the temperature to 25-28° F. The solution is thereby converted to a slush.

In step 2, the slush is broken up by mechanical agitation.

In step 3, the slush is passed through a filter (preferably a 50 micron fiber glass screen) to separate the ice from the liquid water. About ⅔ of the solution is ice and the remaining ⅓ of the solution (the hydronium concentrate) is liquid and passes through the filter.

In step 4, the ice is melted in preparation to making the next batch of hydronium solution. This involves adding sufficient water and sulfuric acid to the solution of melted ice to restore the volume and gram molar strength of step 1 first above to become the starting acid solution of the second above method for the next batch.

In step 5, the filtrate is placed in measuring containers. A measured volume of methanol is added to the concentrate according to 3 parts methanol to 7 parts hydronium ion concentrate. The mixture is stirred whereby most of the calcium sulfate crystallizes.

In step 6, sufficient cationic polymer is added to capture remaining sulfate ions.

In step 7, the solution is poured through a 10-micron fiberglass filter to remove the sulfate-polymer particulates.

In step 8, the hydronium-alcohol concentrate (4.5 to 5.0 moles per liter) is placed in a distillation unit to remove and recover a major portion of the methanol for reuse.

In step 9, the remaining solution is placed in a second batch, low temperature-low pressure distillation unit, and operated until all free water molecules have been removed by distillation. Vapor from the distillation step is permitted to condense and the condensate is added to the starter batch mixture. This eliminates discharge cost and permits recovery of any hydronium ions that have been driven off by the distillation process.

This solution concentrate is known to have applications as a replacement for strong acids in non-ferrous cleaning operations. It is believed that the electrolyte has the following chemical formula: H₉O₄. Prior to the invention herein, this solution concentrate was not known to have utility as a battery electrolyte. The solution concentrate can be purchased from Cognate 3, LLC, 218 Main Street, Suite 287, Kirkland, Wash., USA 98033. Those of ordinary skill in the art are directed to the thesis “The Physical and Chemical Properties of a Thermodynamically Stable Aqueous Sulfuric Acid Solution with Unbalanced Protons,” Clinton R. Mighty, Prairie View A&M University, Prairie View, Tex., Dec. 2, 2004 regarding the stability of hydronium ions.

As is apparent from the above, this electrolyte is free from sulfur. Thus, all of the disadvantages associated with using an acid containing sulfur in an electrical wet cell are avoided. In addition, other advantages have been discovered which are not anticipated from using a sulfurless acid as an electrolyte in a lead-acid battery. In the following examples, the inventive electrolyte is referred to by the following designations, “activated water,” “RSSA-T, “MaxLyte” or “MxLTe.” In all cases, it is believed that the electrolyte has the formula H₉O₄ and is believed to be a stable form of hydronium.

### Example 1

### Test Description

Side-by-side testing of two identically manufactured, new lift-truck batteries is detailed in the following report. One battery was equipped with a standard industry, sulfuric acid electrolyte. The second identical battery was prepared with the MaxLyte electrolyte.

Both batteries were 1190 Amphour (Ah), 48 volt nominal voltage, deep cycle, industrial duty units manufactured by Crown Industries, of Freemont, Ohio, USA. Charge cycles were immediately followed by discharge cycles, using industry standard procedures. Charging was performed from a discharged state of 1.7 volts per cell (40.8 volts, nominal), to a charged state of 2.6 volts per cell (62.4 volts, nominal). Both batteries had previously been charged with an equalizing charge algorithm. This procedure applies a 2.5 volt per cell (60 volts, nominal) potential for an extended time to cause all of the cells to perform at the same level. The effect of the equalizing charge in this test sequence is to remove intercell differences and cause the battery to perform to its highest potential. The discharge test places a 198 ampere load on the battery in an attempt document the highest return possible. Each hour of discharge then produces 198 Ah capacity. Six hours of 198 ampere discharge would then document 100% capacity, 1188 (1190 nominal) Ah.

Each battery began the test with the same specific gravity, 1.280. At the end of each test, the specific gravity was the same for each battery, 1.150.

### Charging

The standard sulfuric electrolyte battery was charged using common industry procedures. The charging voltage was controlled so that a constant current of 200 amps was maintained through the charge cycle until peak voltage was reached. Voltage was then maintained at a constant level so that the amperage fell to finish level of fifteen percent of the capacity, in amphours. The charge was then terminated. This charge protocol required eight hours of charge time.

The MaxLyte electrolyte battery was charged using a patented pulse charge protocol wherein the voltage was controlled at a higher level than standard procedure, so that the current could be held at 600 amps, until the peak voltage was reached. Voltage was then maintained at a constant level so that the amperage fell to finish level of fifteen percent of the capacity, in amphours. This charging protocol required an average of three hours and 20 minutes to complete.

### Temperature

Ambient temperature at the beginning of the tests was the same for each battery, 68° F.

Cell charging temperature for the standard-electrolyte battery was 125° F. At no time did the MaxLyte-electrolyte battery exceed 113° F.

After three charge cycles to normalize the batteries, a series of discharge tests were performed for comparison purposes. The results were as follows:

### Capacity

The standard-electrolyte battery returned an average of 5.25 hour discharge, for a capacity 88% of rated.

The MaxLyte-electrolyte battery returned an average of 6.25 hours of discharge, for a 104% of rated capacity.

The resulting additional Ah capacity is 19% (6.25/5.25) for a 119% capacity.

### Gassing and Odor

As with all sulfuric acid electrolyte batteries, the standard battery began to gas (bubble) at any cellular voltage greater than 2.37 volts. The expected pungent odor of sulfur was evident during the elevated voltage phase of the charge.

The MaxLyte-electrolyte battery exhibited only very minor bubbling and was virtually odor-free during all phases of testing.

### Example 2

48 volt battery test:

| | |
|---|---|
| 24 cells, 2 volt nominal each | |
| 625 Ah rating | |
| Battery had data history recording equipment | |
| Double cables and connectors were installed. | |
| Temp of center cell at start of test: 78° F. | |
| Temp of center cell at finish of test: 116° F. | 38° F. gross rise |
| Ambient temp at start of the test: −58° F. | |
| Ambient temp at finish of the test −62° F. | −4° F. rise in ambient |
| | 34° F. net rise in |
| | inner cell temperature |

Battery was a several year old new battery with a non-use history. In short, it was sulfated. The battery had been charged the night before and was discharged without documentation the morning of the test. Left to inattention, the battery was discharged to 30 volts total (1.25 volts per cell average). Some of the cells that we measured showed 0.5 volts. This coupled with the very short discharge time (approximately 3 hours) tells us that the battery was not a healthy one, due to disuse.

The results of the test are as follows:
Test duration: 2 hr, 7 minute
524 Ah added to battery
At no time did any component get too hot to touch
Battery accepted 84% of capacity charge

36 volt battery test:

| | |
|---|---|
| 18 cells, 2 volt nominal each | |
| 1360 Ah capacity, when new. Battery is 8 years | |
| old, with double connectors and cables installed, | |
| Obviously not in new exercised condition. | |
| Battery had been discharged the night before | |
| to absolutely dead condition. | |
| Temp of center cell at start of test: 64° F. | |
| Temp of center cell at end of test: 100° F. | 36° F. gross rise |
| Ambient temp at start of the test: −62° F. | |
| Ambient temp at finish of the test −63° F. | −1° F. rise in ambient |
| | 35° F. net rise in |
| | inner cell temperature |

The results of the test are as follows:
Test duration: 3.00 hours
1434 Ah added to battery (1360 Ah nominal rating) 5% more than expected
At no time did any component get too hot to touch
   12 volt Pallet Jack Battery with RSSA-T Electrolyte:

Battery was fully charged using an automatic charger, then discharged using the accepted drawdown rate of 75 amps.

The battery has consistently performed well beyond the 6½ period hour for a 100% new battery performance, even though it had been abused before the electrolyte was installed.

The results of the drawdown test: 7 hrs and 15 minutes equaling 544 Ah or 121% of new capacity.

This is exactly what the battery delivered in December, 2003 when it was rebuilt.

I closely monitored the draw rate, and kept it at the 7 5 amp required. Had the test been allowed to follow normal shop techniques, it would likely have run an additional 45 minutes. I feel that this battery is performing at, or above, its performance of nearly 1 year ago.

I feel that all of these tests show that the charger and electrolyte perform demonstrably far above the industry accepted norms.

### Mike Lafferty

Performed by qualified personnel on behalf of EnResCon and in complete co-operation with Michigan Battery Equipment, Inc. of Flint, Mich., using RSSA-T, a safe, non-toxic, non-corrosive, shippable without HAZMAT charge, electrolyte mixture.

### DESCRIPTION

Date started: Jun. 23, 2003
Date completed: Oct. 1, 2003

Tests used a battery that had been in service for an unknown period of time as a standard pallet jack battery. In its original form it had seen service in an 18-volt configuration using nine, two-volt nominal cells. After the first charge/discharge cycle, a decision was made to select the six healthiest cells, and assemble them into a 12-volt configuration. This became the EnResCon test battery and was rated at 450 amphours, being an 11-plate battery with 5 positive plates, rated at 90 amphours per plate.

The next step was to completely discharge the battery, remove the sulfuric acid and replace it with RSSA-T, a proprietary electrolyte mixture. The results of the tests that follow indicate that the RSSA-T yielded an additional 33% amphour capacity, along with the added benefit of a much shorter charging time.

1. Initial Test with 9 Cells and Sulfuric Acid:

The first charge cycle was a successful test, where all cells reached a uniform cell voltage of 2.53 to 2.55 volts. Within the industrial battery rebuilt community; this is generally an excepted indicator of a “healthy” battery.

The first discharge cycle, held at 75 amps, following the above charge cycle, indicated cell capacity was exhausted at the end of the sixth hour. Industrial battery testing generally stops the test when any cell voltage reaches 1.7 volts. The cell voltage was relatively even when taken at that time, with one cell at 1.7 volts. At the end of 6.5-hours, 2 cells were found to be considerably below the 1.7 volts, one cell at 0.71, and one at 0.65. Other cell voltages were widely ranging, between 0.84 and 1.67. That test was terminated, having reached the discharge “knee.”

Conclusion: This would have been considered a good, or 100% battery by industrial standards, as the returned current at 6 hours was at the rated capacity of 450 amphours (6×75).

2. Test 1 using RSSA-T Electrolyte:

After reassembly, using the 6 healthiest cells, the battery was completely discharged and the sulfuric acid drained. The battery was then refilled with RSSA-T, and charged. Cell voltages were brought to 2.35, with only a 0.01-volt variation between the cells. The agreed amount of charge was when the battery had begun to “boil” or gas, therefore the charge had proceeded as long as would be practical.

The first discharge cycle, at a nominal 75 amps, with RSSA-T gave the following conditions: At the beginning of the test, all cells were found with an open circuit voltage within 0.01 of 2.2 volts, note here that this compares with the sulfuric acid voltage of these cells of 2.55 volts, nominal. Cell voltages at the end of the sixth hour were within 0.01 volts of 1.82; note that the sample test with sulfuric acid had 1.7 volts. This discharge test lasted until the “knee” occurred abruptly at 7 hours. The lowest cell voltage at this time was 1.58, ranging to 1.7 volts. The digital amphour meter failed at the 5.5-hour point, representing a 73.8 amp discharge rate. Using the 73.8 amp discharge rate as the guideline, failure at the 7-hour test marker, yields a 516-amphour return.

This represents a 15% ((516×100)/450)) increase in capacity for the first test after converting to RSSA-T.

3. Successive Tests using RSSA-T:

In all discharge tests using the same 75-amp discharge rate, open circuit voltages gradually improved from 2.2 to 2.6 volts, a slight increase from the 2.55 of the battery when using sulfuric electrolyte.

Discharge test cell voltages climbed gradually at the 6-hour mark (100% test time) to 1.9 volts. Each hourly test gave similar improvements over the conventional sulfuric acid. Notably, the cell voltage at the 5-hour test time showed an increase from 1.84 with sulfuric, with 1.96 volts with the RSSA-T.

During one test, the battery was left on discharge for an extended time beyond the normal 6-hour test, in order to determine when the discharge “knee” would occur. That test was terminated at 8 hours, without reaching the value of 1.7 volts at any cell. The lowest cell registered 1.71 volts. This represents a return of 600 amphours, a 33% (600/450) increase in capacity, over the original sulfuric acid test. No significant temperature increases noted in any of the above charging or discharging tests.

4. Rapid Charge Rates using RSSA-T:

In 2 tests using charge rates that were much more aggressive than industry rates, the RSSA-T electrolyte performed admirably. The normal recharge rate for the above battery would be 75 amps. This would usually be decreased at the 5-hour mark to a value that would be essentially a “trickle charge”, used to equalize and prevent sulfation of the plates, which cannot happen with RSSA-T electrolyte.

During the first accelerated charge test, the amperage was increased to 150 amps. This test was terminated when the RSSA-T electrolyte warmed to 125 F.°. This test lasted a total of 3.5 hours, with a total of 524 amphours being added to the battery. This test represented a 56% (100×(1−(3.5/8))) reduction of charge time.

A second test at a less-aggressive rate of 115 amps, lasted 4 hours and 50 minutes (4.83 hrs), resulted in adding 560 amphours to the battery, before having the temperature reach 125 F.°. This test represents a 40% (100×(1−(4.83/8))) reduction in time charge.

### 5. Specific Gravity:

In all tests, the specific gravity of the RSSA-T reached or exceeded industry acceptable values, based on sulfuric acid. Temperature corrected values reached 1.330.

### 6. Practical Use:

It must be said that while the above tests were being conducted from time to time, the EnResCon battery was put to practical use in an industrial walking forklift. This power unit is the main forklift for moving other batteries of up to 4,000 pounds out of the warehouse to a staging area for shipping. The EnResCon battery was put on an overnight automatic charger two to three times a week and pulled out of service only for running these tests. As has been reported to us, this battery is their “preferred” battery, as it appears to perform better than their regular battery. This battery remains in use in this manner waiting further testing.

### 7. All Certified Worksheets and Data are on File.

Prepared and dated Oct. 24, 2003

### Stephanie Blackwell

### President

### Environmental Restoration Contracting, Inc.

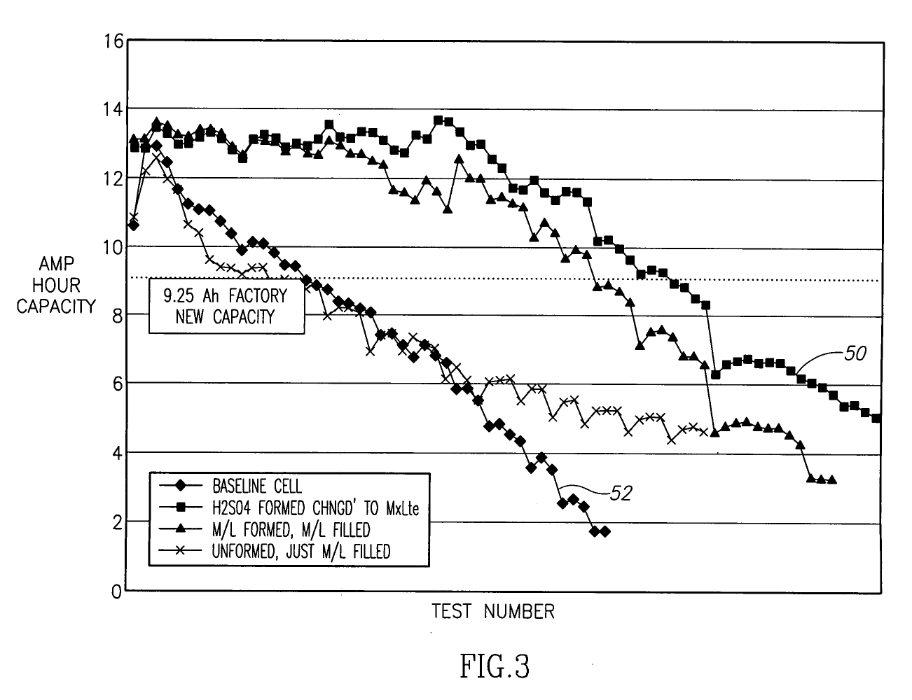

FIG. 3 illustrates a graph summarizing the amperhour capacity of a conventional battery using sulfuric acid (H₂SO₄) as an electrolyte versus the inventive electrolyte (i.e., MaxLyte). The draft compares a standard 9.25 amphour factory new capacity battery 50 versus a conventional base line battery 52 utilizing conventional sulfuric acid electrolyte over a number of charge/discharge cycles. It is apparent from FIG. 3 the conventional battery having been reformed with the inventive electrolyte 50 demonstrates the superior life cycle, duty cycle and amphour capacity.

When constructing a new battery for use with the inventive electrolyte, the change in modality for such new battery manufactured with the inventive electrolyte is as follows. Upon finishing the construction of the battery, it is filled with inventive electrolyte and formed the prescribed the amount for the type of battery it is and simply put into to use. The battery voltage will continue to increase in capacity with discharging and charging until it reaches full capacity which is from 25% to 50% more than standard capacity depending upon which type of battery it is. When reforming a battery which has been previously used with standard sulfuric acid electrolyte, the following process is employed. The battery must have the sulfuric acid electrolyte installed and be placed on a load such that the battery will be run down completely dead. Next, the battery is short circuited by placing a jumper cable connected post to post for 24 hours. It is believed that this process exhausts all the sulfuric acid active coating from the plates. The battery then must be emptied of the exhausted sulfuric acid electrolyte solution and washed out with water at least twice. The battery is then filled with the inventive electrolyte and a reforming charge of at least two to five times the capacity of the battery is installed.

An old, sulfated deceased battery may also be reformed with the inventive electrolyte as follows. The battery must be discharged until it is dead and then short circuited by placing a jumper cable from post to post for 24 hours. The old electrolyte is removed and then the battery is rinsed with water turning the battery upside down each time until the water comes out clean. The battery is then filled with the inventive electrolyte and charged at least two to five times the original battery capacity. Unless the battery is shorted and ruined, it will come up to at least the original or better capacity.

A preferred method for charging either batteries newly formed with the inventive electrolyte, or old sulfuric acid batteries reformed with the inventive electrolyte is described in detail in U.S. Pat. No. 6,388,425 issued to Petrovic on May 14, 2002 entitled Rapid Charging Battery and Apparatus, the disclosure of which is incorporated herein by reference.

Those of ordinary skill in the art will conceive of other alternate embodiments of the invention upon reviewing this disclosure. Thus, the invention is not to be limited to the above description, but is to be determined in scope by the claims which follow.

I claim:

1. An improved wet cell battery, comprising
a substantially fluid impervious battery case;
an anode plate, a cathode plate, and an ion porous separator between the anode and cathode plates all substantially received in the battery case; and
a substantially sulfur free electrolyte in solution with water in the battery case.

2. The improved wet cell battery of claim 1, wherein the electrolyte solution consists essentially of H₉O₄.

3. The improved battery of claim 2 wherein the plates are formed and not charged prior to introduction of the electrolyte into the battery such that the electrolyte is not introduced into a dry charged cell.

4. A method of reforming a wet cell battery having a rated capacity previously used with a sulfuric acid electrolyte comprising the following steps:
placing an electrical load on the battery;
discharging the battery substantially completely;
short circuiting the battery for approximately 24 hours;
emptying the battery of substantially all sulfuric acid electrolyte;
flushing the battery twice with water;
filling the battery with a substantially sulfurless electrolyte; and,
applying a reforming charge of at least approximately twice the rated capacity of the battery.

5. The method of claim 4, wherein the substantially sulfurless electrolyte is H₉O₄.

6. The method of claim 5 wherein the reforming charge is at least two to five times the rated capacity of the battery.
